(19) United States
(12) Patent Application Publication
(10) Pub. No.: US 2018/0288951 A1
(43) Pub. Date: Oct. 11, 2018

(54) ADJUSTABLE TRELLIS SYSTEM

(71) Applicant: A & J Vineyard Supply, Inc., St. Helena, CA (US)

(72) Inventors: Jennifer Di Battista, St. Helena, CA (US); Augusto Di Battista, St. Helena, CA (US)

(73) Assignee: A & J Vineyard Supply, Inc.

(21) Appl. No.: 15/947,106

(22) Filed: Apr. 6, 2018

Related U.S. Application Data
(60) Provisional application No. 62/482,474, filed on Apr. 6, 2017.

(51) Int. Cl. A01G 17/06; F16B 21/12

(52) U.S. Cl. CPC A01G 17/06; F16B 21/12

(57) ABSTRACT

A trellis system and method are provided that permit customizable orientation of support arms. The arms are independently movable to various positions and may be locked in the selected positions. The arms may be repeatedly repositioned and locked as the plant it supports continues to grow.

### PRIORITY

This patent application claims priority to and benefit of U.S. Provisional Patent Application Number 62/482,474 filed on 6 Apr. 2017, the disclosure of which is now expressly incorporated herein by reference

### BACKGROUND

The disclosed embodiments relate generally to systems and methods for an adjustable trellis for growing vinous plants.

### SUMMARY

Disclosed embodiments provide systems that permit independent orientation management of a plurality of grape vines via a trellis head with independently adjustable arms.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 illustrates a trellis configured to support two grape vine cordons;

FIG. 2 is a close-up perspective view of the adjustable trellis head of the trellis according to the embodiment of FIG. 1;

FIG. 2A is an illustrative enlarged view of the locking mechanism of FIG. 2 from a back view of the trellis head;

FIG. 2B is an illustrative enlarged sectional view of an alternative locking mechanism from a side view of the trellis head;

FIG. 3 is a planar view of the support plate of the adjustable trellis head according to the embodiment of FIG. 2;

FIG. 4 is a cross-sectional view taken along line 4-4 of the support plate of FIG. 3;

FIG. 5 is a planar view of another embodiment of a support plate of the adjustable trellis head according to the embodiment of FIG. 2, and

FIG. 6 is a cross-sectional view taken along the line 6-6 of the support plate of FIG. 5.

### DETAILED DESCRIPTION

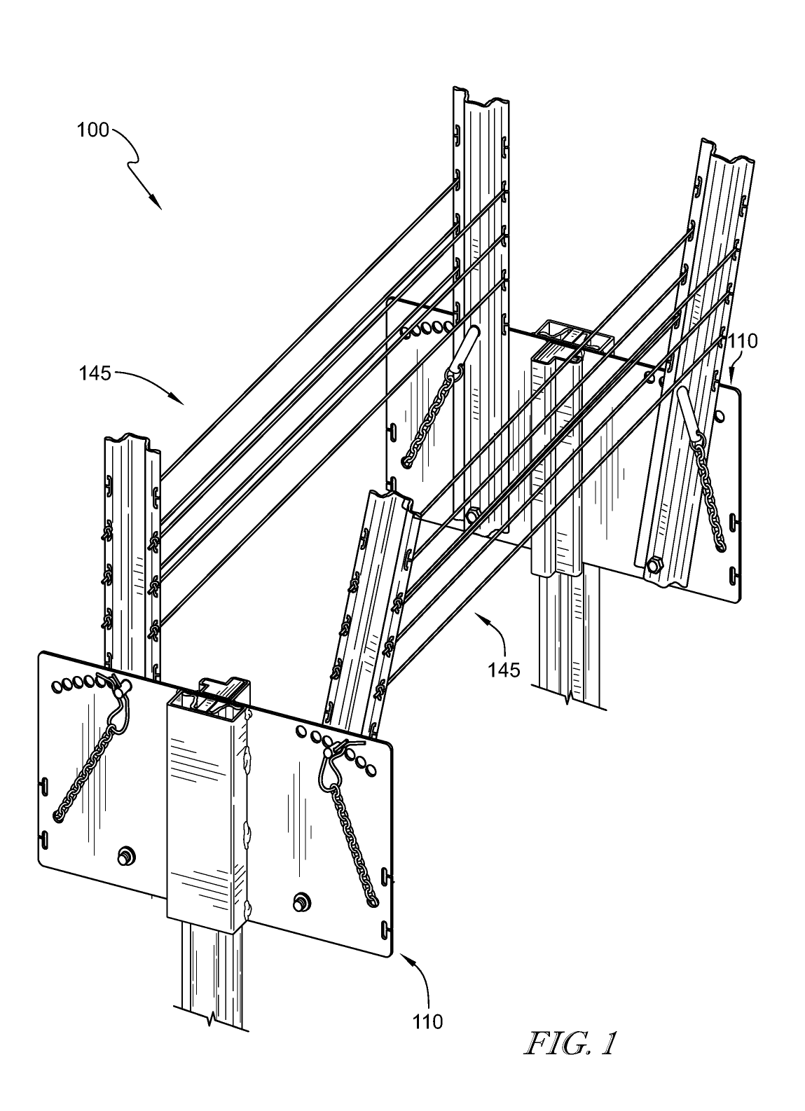

One embodiment of the presently disclosed customizable trellis system 100 for growing vinous plants and adjusting the angular orientation of the vines is shown in FIG. 1. The system may include an adjustable trellis head 110 and an attachable post 120 that may be coupled to the trellis head to install and anchor the trellis system 100 into the ground. The trellis system 100 may support a plurality, e.g., two or more plants between each adjustable trellis head 110 with each plant's foliage being supported by a plurality of exterior foliage/canopy wires 145.

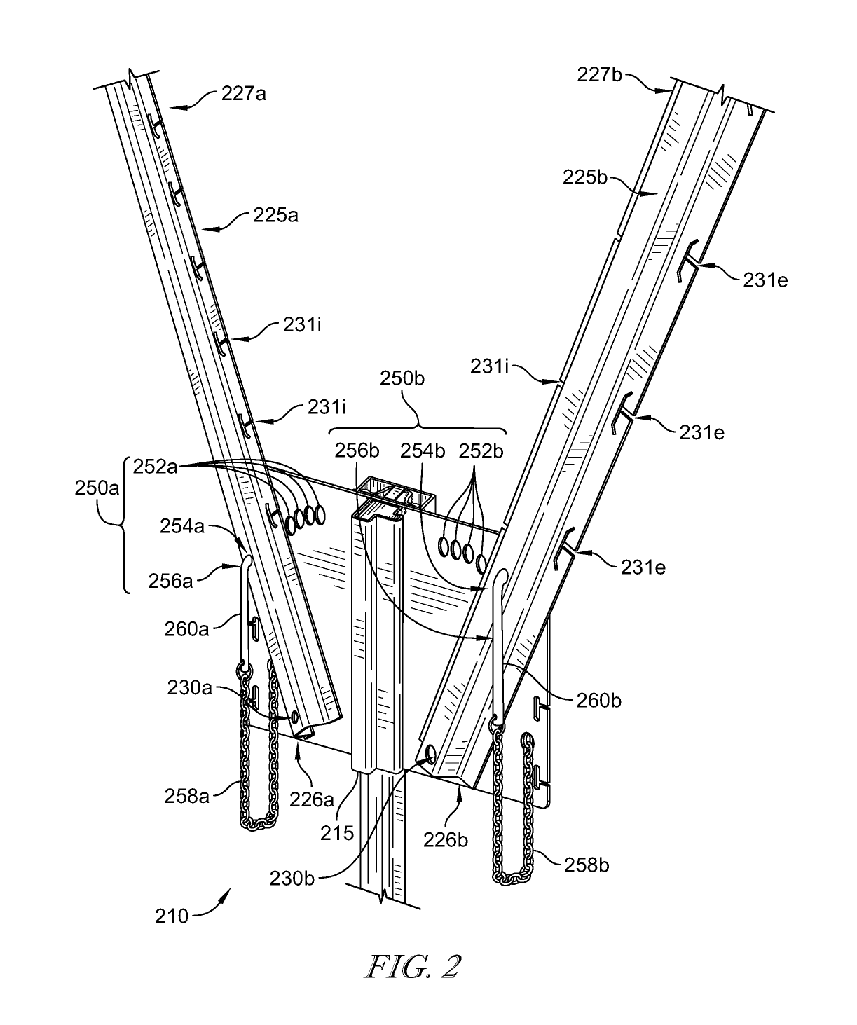

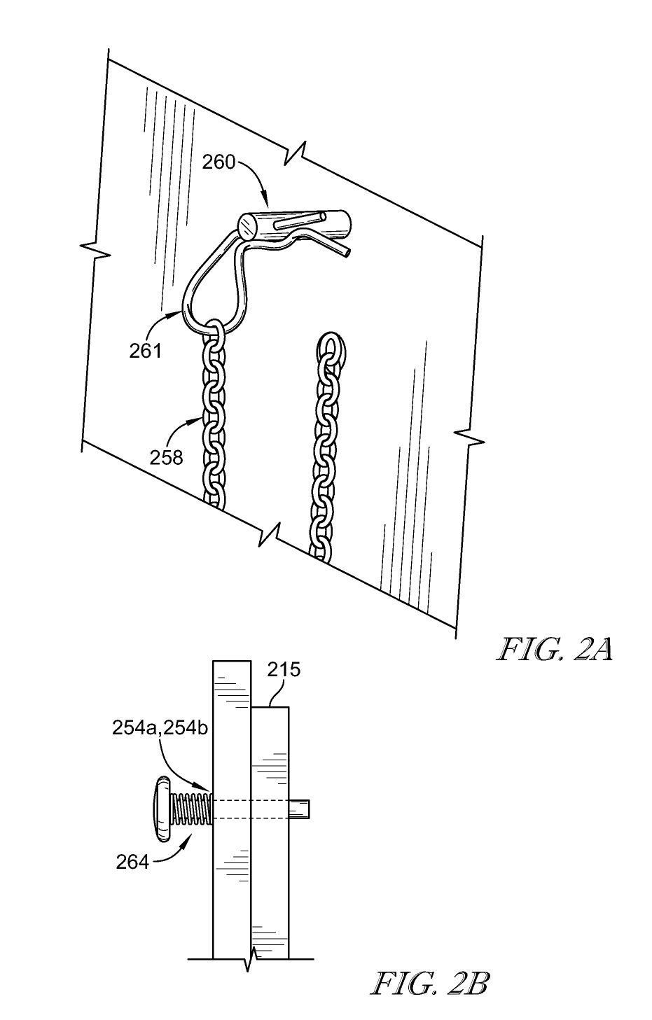

Trellis head 210, as seen in FIG. 2, may include a support plate 215, first and second rotatable arms 225a, 225b, and first and second orientation adjustment mechanisms 250a 250b. Rotatable arms 225a, 225b may each include proximal ends 226a, 226b, and distal ends 227a, 227b. Spaced apart along each of the rotatable arms 225a, 225b may be a plurality of foliage/canopy management wire notches 231.

In accordance with at least one embodiment, each rotatable arm may have a plurality, e.g., eight, foliage/canopy management wire notches 231, with a plurality, e.g., four, interior foliage/canopy management wire notches 231i and a plurality, e.g., four, exterior foliage/canopy management wire notches 231e spaced equidistant along the length of each rotatable arm 225a, 225b. It is contemplated that different numbers of notches may be provided along the rotatable arms 225a, 225b, which may allow for multiple sets of wires to be used simultaneously and/or may allow for the movement of a single set of wires up or down as needed within the foliage/canopy management wire notches 231 on the rotatable arms.

Rotatable arms 225a, 225b may be mounted independent of each other to the support plate 215 at pivots 230a, 230b. Pivots 230a, 230b may be secured by any one of bolts, screws, pins, rivets, or other known securing pivot couplings. Rotatable arms 225a, 225b may be configured to be independently adjusted to a plurality of different positions along the support plate 215 and secured in a selected position via orientation adjustment mechanisms 250a, 250b.

Each orientation adjustment mechanism 250a, 250b may include an orientation opening 252a, 252b in the support plate 215, an arm opening 254a, 254b and a lock 256a, 256b. Orientation openings 252a, 252b may be configured to align with the arm openings 254a, 254b as the rotatable arms 225a, 225b rotate about pivots 230a, 230b. Locks 256a, 256b may extend through an aligned orientation opening 252a, 252b and respective aligned arm opening 254a, 254b to secure each rotatable arm 225a, 225b in a selected locked orientation.

Each lock 256a, 256b, as illustrated, may include a safety chain 258a, 258b, and a locking pin 260a, 260b coupled to the safety chain 258a, 258b at one end by a metal ring, sized and shaped to be inserted and pass through the orientation opening 252a, 252b and arm openings 254a, 254b at the other end to maintain the openings in fixed alignment when in the selected locked orientation. Locking pin 260a, 260b as illustrated includes a bend in the body of the locking pin to prevent the locking pin 260a, 260b from passing completely though the orientation opening 252a, 252b and arm openings 254a, 254b and provides for easier gripping of the locking pin during manipulation. Each locking pin 260 may include a bobby-pin like metal clip 261 at the other end of safety chain 258 that inserts into an opening in the pin as seen in the enlarged view in FIG. 2A to secure the pin in place. Alternatively the locking may consist of a spring-loaded pin 264 that is mounted to each arm opening 254a, 254b, in a compressed state so that it is biased to extend through the arm opening 254a, 254b and through the support plate 215 via orientation openings 252a, 252b. The spring-loaded pin 264 may be removed from the orientation openings 252a, 252b by pulling on the head of the pin 264, thereby placing the spring in tension until an appropriate orientation opening is selectively aligned.

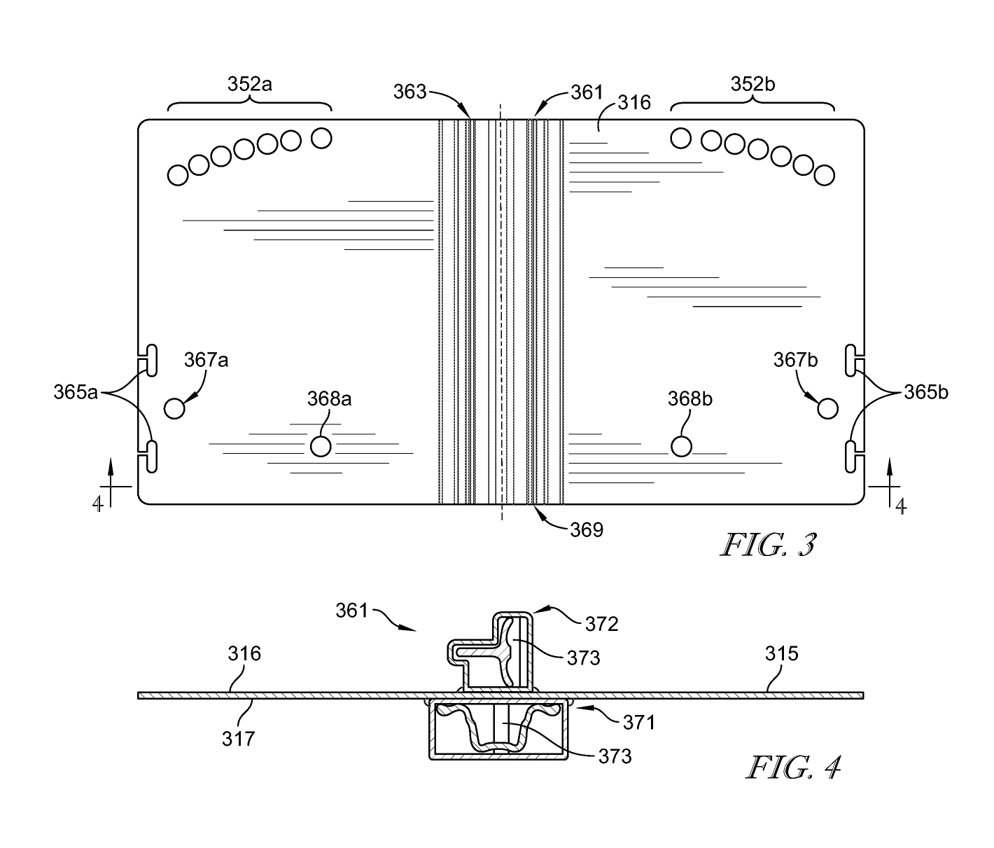

As seen in FIG. 3, the support plate 315 may include a post adapter 361, notches 365a, 365b and orientation openings 352a, 352b. Support plate 315 may be symmetrical about vertical axis C-L. In the illustrative embodiment, there are a plurality, e.g., seven, orientation openings 352a spaced apart along an arcuate path for the first rotatable arm 254a to be adjusted along and a plurality, e.g., seven or eight, orientation openings 352b spaced apart along an arcuate path for second orientation arm 254b to be oriented along as the rotatable arms 254a, 254b move about pivot openings 368a, 368b. It is contemplated that more or fewer orientation openings than the number illustrated may be provided along the arcuate path based on the number of orientation positions that may be needed for the rotatable arms.

Notches 365a, 365b may be configured to secure fruiting wires (not shown) that vinous plants' main fruit bearing shoots may grow along. Chain openings 367a, 367b may be sized to permit safety chains 258a, 258b to pass freely therethrough, while preventing locking pins from passing through.

As can be seem in the sectional view of FIG. 4, post adapter 361 may be coupled to the front 316 and back 317 surfaces of support plate 315. As can be seen, the adapter 361 may be configured to permit the system to mount to two different kinds of posts. In this illustrative embodiment, the adapter 361 can mount an adjustable trellis head to posts of one geometry such as rolled-edge posts on one side mount 371 and/or posts of a different geometry such as t-posts on the opposite side mount 372. Post adapter is capped 373 at top end 363 and opened at the bottom end 369 permitting the support plate 315 to be slid onto a post when the post has been installed.

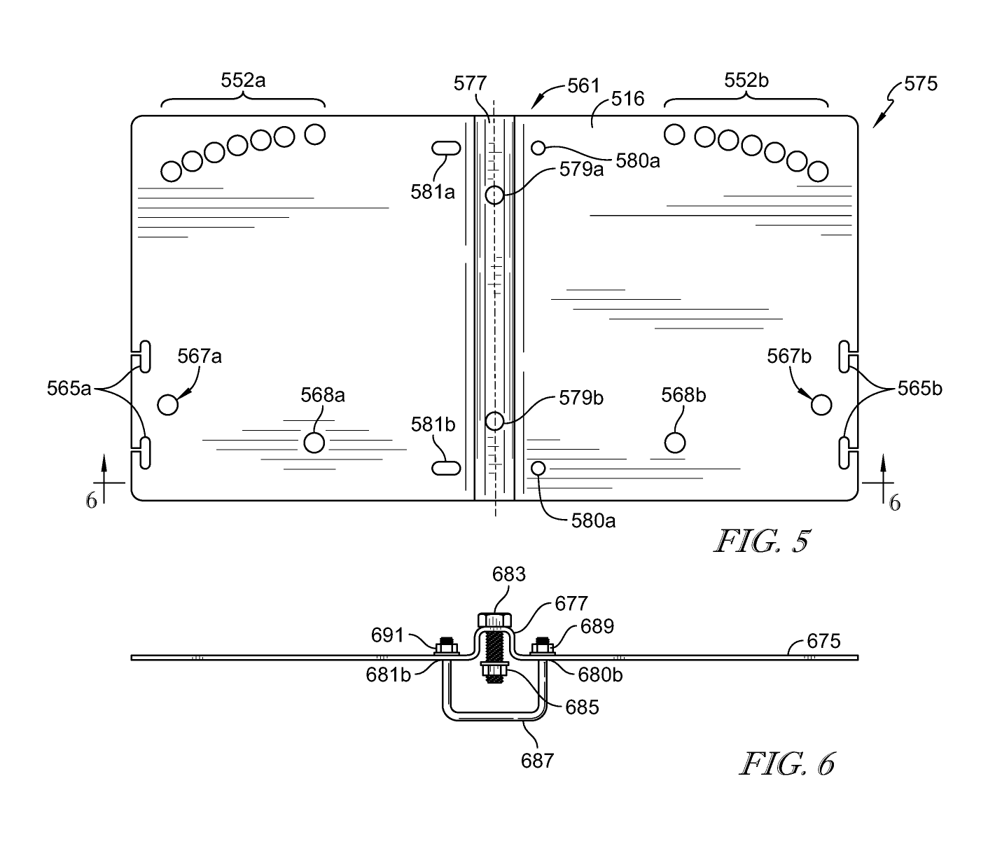

According to an alternative embodiment, support plate 575 may include an integrated universal post adapter 577 so that the support plate and integrated post adapter are monolithic. Reference numbers in the 500 series in FIG. 5 correspond to the components in the 300 series in FIG. 3 unless otherwise indicated. The integrated post adapter 577 is formed as a sloped bend, or channel in the support plate 575 so that the area of the support plate 575 outside of the region of the integrated post adapter 577 lies in a single plane. Integrated post adapter 577 includes two bolt securement holes 579a 579b vertically aligned and spaced apart along a vertical plane of the support plate 515. In the planar region of the support plate, an elongate securement hole 581a and a circular securement hole 580a are located on either side of the channel and above a bolt securement hole 579a along a horizontal plane of the support plate 575. A set of a second elongate securement hole 581b and second circular securement hole 580b are located on either side of channel below second bolt securement hole 579b along a second horizontal plane of the support plate 575. In some embodiments, elongate securement holes 581a, 581b, and circular securement holes 580a, 580b may be located on opposite sides of the support plate 575 than the sides depicted in FIG. 5.

As can be seem in the sectional view of FIG. 6, integrated post adapter 677 can cooperate with bolts 683 and 687 to secure any shaped post to the support plate 675. Although the securement arrangement is described and depicted only with respect to the lower set of bolt and securement holes 579b, 580b, 581b in FIG. 6, an identical arrangement is present with respect to the upper set of bolt and securement holes 579a, 580a, 581a. Bolt 683 may be positioned to extend through bolt securement hole 679b, and through any type of post (not shown) and secured via a threaded nut 685. Further securement is provided by a U-shaped bolt 687. U-bolt may surround a post and free ends of the U-shaped bolt 687 may extend through elongate securement hole 681b and circular securement hole 680b and be secured to the support plate 675 via first and second threaded nuts 691, 689. A method of adjusting the exposure of grape vines may utilize a trellis system as disclosed above. As part of that method, a first locking mechanism may be released and a first rotatable arm may be rotated about a pivot on a support plate to align an opening on the arm with an opening in the support plate at a desired angular orientation. The first locking mechanism may then be inserted into the aligned openings to lock the orientation. This process may be repeated with a second locking mechanism with a second rotatable arm to position it in a second desired angular orientation, which may be the same or different than the first angular orientation. This process may be repeated as needed during the growing season.

The trellis system according to the disclosed embodiments enables for flexibility and customization throughout the lifespan of a grape plant. This is particularly important for the optimization of air, light and heat exposure to the fruit during the growing season. For instance, grape cordons are typically thinned of leaves earlier in the season so that the fruiting zone has greater exposure to the sun and heat. Rotatable arms may be positioned to raise the foliage canopy further away from the cordon at this time to also maximize airflow. The post adapter mounted on the trellis head allows multiple different shaped posts to be used and eliminates the need for any kind of external attachment hardware (u-bolts, bolts & nuts, etc.) thereby significantly reducing labor time and cost.

However, later in the growing season when the grapes are more mature, it may be desirable to shade the grapes. This typically is done through shade cloths to compensate for the thinning of the leaves. The system allows the foliage to simply be rotated down towards the earth so that the fruit growing shoots may be shaded by the natural canopy of the foliage. Additionally, one side of a row may need more light while the other side of the row may need more shade depending on the orientation of the rows of plants, time of year, etc. The disclosed system permits cordons to be split perpendicularly to grow on the same trellis and be independently managed by the raising or lowering of the foliage canopy confined within the sets of wires positioned along the rotatable arms.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

1. A trellis system comprising:
a trellis head with first and second rotatable arms mounted pivotably to a plate; and
means for independently adjusting the first and second rotatable arms into fixed positions by rotating one or both of the arms independent of the other and locking the arm in a desired angular orientation so that each arm is in a fixed angular orientation relative to the plate of the trellis head.

2. The trellis system of claim 1, wherein the means for independently adjusting the first and second rotatable arms comprises first orientation openings on the plate, a first arm opening that rotatably aligns with the first orientation openings extending through the plate, and a first lock that fixes the first rotatable arm at one of the first plurality of holes, and
second orientation openings extending through the plate, a second arm opening that rotatably aligns with the first orientation openings extending through the plate, and a second lock that fixes the second rotatable arm at one of the second plurality of holes.

3. The trellis system of claim 2, wherein the first lock and second locks comprise angled locking pins fed through openings in the plate via a safety chain.

4. The trellis system of claim 2, wherein the first orientation openings are spaced apart equidistantly from each other along the plate.

5. The trellis system of claim 4, wherein the second orientation openings are spaced apart equidistantly from each other along the plate.

6. The trellis system of claim 1, wherein the trellis head further comprises a post adapter configured to mount a post having a particular geometry on a front side of the plate and a post having a different geometry on a back side of the plate.

7. The trellis system of claim 6, wherein the plate is symmetrical about the post adapter.

8. The trellis system of claim 1, wherein each arm is independently adjustable to a different fixed angular orientation relative to the plate of the trellis head.

9. The trellis system of claim 8, wherein each arm comprises a plurality of foliage wire notches, and wherein foliage wires are secured in and extend from the notches.

10. The trellis system of claim 1, wherein the plate further comprises an integrated post adapter formed as a bend in the plate with bolt securement holes.

11. The trellis system of claim 10, comprising further securement holes positioned on each side of the bend in the plate.

12. A trellis system comprising:
a plate having a plurality of openings extending therethrough,
at least one arm rotatably mounted to the plate, the at least one arm having a first arm opening configured to align with each of the plurality of openings as the arm rotates, and
a locking pin configured to extend partially through the at least one arm and an aligned opening to lock the at least one arm in a fixed angular orientation.

13. The trellis system of claim 12, wherein the at least one arm comprises two arms rotatably mounted to the plate, wherein each arm is configured to be moved and locked independently.

14. The trellis system of claim 13, wherein each arm is configured to be locked at a different fixed angular orientation.

15. The trellis system of claim 14, further comprising a second locking pin, wherein each arm is locked by a respective locking pin.

16. The trellis system of claim 14, wherein each arm comprises a plurality of foliage wire notches configured to secure and extend foliage wires as a plant grows up within the confines created by the trellis arms.

17. The trellis system of claim 12, wherein the plate further comprises a post adapter configured to mount the plate to posts of different geometries.

18. The trellis system of claim 12, wherein the plate further comprises an integrated posted adapter formed as a bend in the plate with bolt securement holes.

19. The trellis system of claim 18, comprising further securement holes positioned on each side of the bend in the plate.

20. The trellis system of claim 12, wherein the plate is symmetrical about a vertical axis.
